(19) United States
(12) Patent Application Publication
(10) Pub. No.: US 2014/0114730 A1
(43) Pub. Date: Apr. 24, 2014

(54) SYSTEM AND METHOD FOR CAPABILITY DEVELOPMENT IN AN ORGANIZATION

(71) Applicant: BANK OF AMERICA CORPORATION, Charlotte, NC (US)

(72) Inventors: Madhuri Deshpande, Mumbai (IN); Bhavna Agarwal, Mumbai (IN); Sudheer Ramakrishnan, Mumbai, (IN)

(73) Assignee: Bank of America Corporation, Charlotte, NC (US)

(21) Appl. No.: 13/657,009

(22) Filed: Oct. 22, 2012

(51) Int. Cl. G06Q 10/06

(52) U.S. Cl. 705/7.42

(57) ABSTRACT

Developing capability within an organization comprises receiving a skill associated with a position in an organization from a first computer associated with a manager. A skill level associated with the received skill is determined. A capability assessment level associated with the skill is received, and the skill level and the capability assessment level are compared to determine a current state. If the skill level is greater than the capability assessment level, a training program based on the capability assessment level and the skill level is determined.

### TECHNICAL FIELD OF THE INVENTION

This invention relates generally to capability development, and more particularly to capability development in an organization.

### BACKGROUND OF THE INVENTION

Organizations require their workers to exhibit various skills for their roles in an organization. Each worker within the organization may perform the assigned skills at a particular level. In a typical organization, the skills required for the role and the worker's performance at a particular level are not integrated.

### SUMMARY OF THE INVENTION

According to embodiments of the present disclosure, disadvantages and problems associated with developing capabilities within an organization may be reduced or eliminated.

In certain embodiments, developing capability within an organization comprises receiving a skill associated with a position in an organization from a first computer associated with a manager. A skill level associated with the received skill is determined. A capability assessment level associated with the skill is received, and the skill level and the capability assessment level are compared to determine a current state. If the skill level is greater than the capability assessment level, a training program based on the capability assessment level and the skill level is determined.

Certain embodiments of the present disclosure may provide one or more technical advantages. A technical advantage of one embodiment includes providing a learning and talent management framework to measure employee capability and maturity development. Another technical advantage includes determining a particular training program based on a current capability level and a desired capability level. Yet another technical advantage includes providing a knowledge management structure and standardized approach to leverage consistent employee development that is mapped to organization standards; thereby creating an environment to promote maturation of organizational capability. By promoting associate development and maturation, an organization may further experience efficiency in other resources, such as computing resources.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates a block diagram of an embodiment of a system for capability development in an organization;

FIGS. 2A-2B illustrate flowcharts for capability development in the organization;

FIG. 3 illustrates an example chart that indicates overall capability results of an associate;

FIG. 4 illustrates example charts that indicate capability results in specific skill areas;

FIG. 5 illustrates an example chart that indicates the capability results of various business units in the organization;

FIG. 6 illustrates an example table that indicates capability results of various business units in the organization; and

FIG. 7 illustrates an example of the lifecycle of the capability development in the organization.

### DETAILED DESCRIPTION OF THE INVENTION

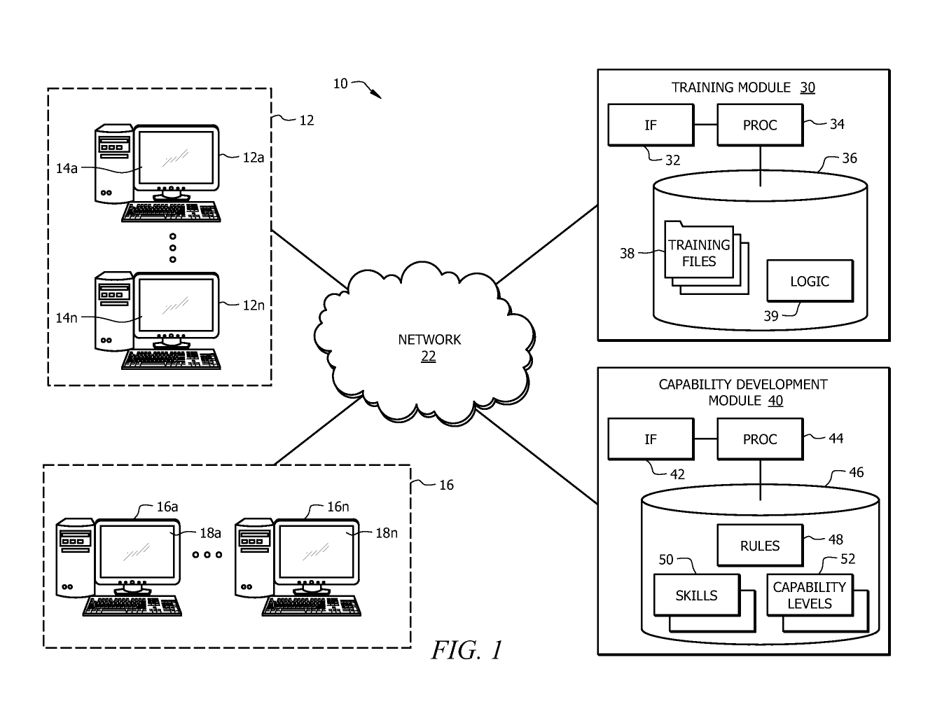

Embodiments of the present invention and its advantages are best understood by referring to FIGS. 1 through 7 of the drawings, like numerals being used for like and corresponding parts of the various drawings.

FIG. 1 illustrates a block diagram of an embodiment of a system 10 for capability development in an organization. System 10 includes one or more manager computers 12 and one or more associate computers 16 that communicate over one or more networks 22 with training module 30 and capability development module 40 to facilitate the development of an associate within an organization. Manager computer 12 interacts with capability development module 40 to establish particular skills associated with a job in the organization. Capability development module 40 determines a skill level for each skill. Manager computer 12 and/or associate computer 16 provide a capability assessment level to capability development module 40, and capability development module 40 determines a training program based on a comparison between the skill level and the capability assessment level.

Using capability development module 40, an organization may provide a unified framework to measure skills required for a particular job and calibrate associate's capabilities with the skills. Therefore, associates may continually enhance their capabilities within an organization and the organization may benefit from having trained and developing associates. Having trained and developing associates improves the efficiency of an organization. Furthermore, computing resources and bandwidth may be conserved by improving the efficiency of the organization through its associates.

System 10 includes manager computers 12a-12n, where n represents any suitable number, that communicate with training module 30 and capability development module 40 through network 22. For example, manager computer 12 communicates with training module 30 to monitor the progress of associates in completing training programs. As another example, manager computer 12 communicates with capability development module 40 to provide skills associated with a particular position and/or to receive results based on the evaluation of an associate. In the illustrated embodiment, managers within an organization use manager computer 12. Managers may represent any individual in an organization that has subordinates or manages one or more people in the organization. Manager computer 12 may include a personal computer, a workstation, a laptop, a wireless or cellular telephone, an electronic notebook, a personal digital assistant, a smartphone, a netbook, a tablet, a slate personal computer, or any other device (wireless, wireline, or otherwise) capable of receiving, processing, storing, and/or communicating information with other components of system 10. Manager computer 12 may also comprise a user interface, such as a display, keyboard, mouse, or other appropriate terminal equipment.

In the illustrated embodiment, manager computer 12 includes a graphical user interface (“GUI”) 14 that displays information received from training module 30 and/or capability development module 40. For example, GUI 14 may display capability information to a manager using manager computer 12. GUI 14 is generally operable to tailor and filter data entered by and presented to the user. GUI 14 may provide the user with an efficient and user-friendly presentation of information using a plurality of displays having interactive fields, pull-down lists, and buttons operated by the user. GUI 14 may include multiple levels of abstraction including groupings and boundaries. It should be understood that the term GUI 14 may be used in the singular or in the plural to describe one or more GUIs 14 in each of the displays of a particular GUI 14.

System 10 also includes associate computers 16a-16n, where n represents any suitable number, that communicate with training module 30 and capability development module 40 through network 22. For example, associate computer 16 communicates with training module 30 to receive training programs as determined by capability development module 40. In the illustrated embodiment, associates within an organization use associate computer 16. Associates may represent any individual in an organization that reports to another person in the organization. In an embodiment, associates may also be managers within the organization. Associate computer 16 may include a personal computer, a workstation, a laptop, a wireless or cellular telephone, an electronic notebook, a personal digital assistant, a smartphone, a netbook, a tablet, a slate personal computer, or any other device (wireless, wireline, or otherwise) capable of receiving, processing, storing, and/or communicating information with other components of system 10. Associate computer 16 may also comprise a user interface, such as a display, keyboard, mouse, or other appropriate terminal equipment.

In the illustrated embodiment, associate computer 16 includes a graphical user interface (“GUI”) 18 that displays information received from training module 30 and/or capability development module 40. For example, GUI 18 may display training information to an associate using associate computer 16. GUI 18 is generally operable to tailor and filter data entered by and presented to the user. GUI 18 may provide the user with an efficient and user-friendly presentation of information using a plurality of displays having interactive fields, pull-down lists, and buttons operated by the user. GUI 18 may include multiple levels of abstraction including groupings and boundaries. It should be understood that the term GUI 18 may be used in the singular or in the plural to describe one or more GUIs 18 in each of the displays of a particular GUI 18.

Network 22 represents any suitable network operable to facilitate communication between the components of system 10 such as manager computers 12, associate computers 16, training module 30, and capability development module 40. Network 22 may include any interconnecting system capable of transmitting audio, video, signals, data, messages, or any combination of the preceding. Network 22 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

Training module 30 represents any suitable component that facilitates the provision of training programs to managers and associates within an organization. Training module 30 may include a network server, any suitable remote server, a mainframe, a host computer, a workstation, a web server, a personal computer, a file server, or any other suitable device operable to communicate with manager computers 12, associate computers 16, and/or capability development module 40. In some embodiments, training module 30 may execute any suitable operating system such as IBM's zSeries/Operating System (z/OS), MS-DOS, PC-DOS, MAC-OS, WINDOWS, UNIX, OpenVMS, or any other appropriate operating system, including future operating systems. The functions of training module 30 may be performed by any suitable combination of one or more servers or other components at one or more locations. In the embodiment where training module 30 is a server, the server may be a private server, or the server may be a virtual or physical server. The server may include one or more servers at the same or remote locations. Also, training module 30 may include any suitable component that functions as a server. In the illustrated embodiment, training module 30 includes a network interface 32, a processor 34, and a memory 36.

Network interface 32 represents any suitable device operable to receive information from network 22, transmit information through network 22, perform processing of information, communicate with other devices, or any combination of the preceding. For example, network interface 32 receives a request from associate computer 16 to access training files 38. As another example, network interface 32 may communicate training files 38 to associate computer 16 for the associate to complete the training. As yet another example, network interface 32 may communicate training files 38 to capability development module 40. Network interface 32 represents any port or connection, real or virtual, including any suitable hardware and/or software, including protocol conversion and data processing capabilities, to communicate through a local area network (LAN), wide area network (WAN), or other communication system that allows training module 30 to exchange information with network 22, manager computers 12, associate computers 16, capability development module 40, or other components of system 10.

Processor 34 communicatively couples to network interface 32 and memory 36, and controls the operation and administration of training module 30 by processing information received from network interface 32 and memory 36. Processor 34 includes any hardware and/or software that operates to control and process information. For example, processor 34 executes logic 39 to control the operation of training module 30. Processor 34 may be a programmable logic device, a microcontroller, a microprocessor, any suitable processing device, or any suitable combination of the preceding.

Memory 36 stores, either permanently or temporarily, data, operational software, or other information for processor 34. Memory 36 includes any one or a combination of volatile or non-volatile local or remote devices suitable for storing information. For example, memory 36 may include random access memory (RAM), read only memory (ROM), magnetic storage devices, optical storage devices, or any other suitable information storage device or a combination of these devices. In the illustrated embodiment, memory 36 includes training files 38 and logic 39. Training files 38 generally refer to programs that provide training to associates and managers within an organization. Training files 38 may include web courses, virtual classrooms, training documents, or any other suitable tool to facilitate training within the organization. Logic 39 generally refers to logic, rules, algorithms, code, tables, and/or other suitable instructions embodied in a computer-readable storage medium for performing the described functions and operations of training module 30. While illustrated as including a particular module, memory 36 may include any suitable information for use in the operation of training module 30.

Capability development module 40 represents any suitable component that facilitates the management and integration of capability assessment and training within a organization by communicating with manager computers 12, associate computers 16, and training module 30. Capability development module 40 analyzes skill levels and capability assessment levels to determine training programs for an associate to improve their skill set. Capability development module 40 may also create various reports based on the analysis and comparison of the skill levels and the capability assessment levels. Additionally, capability development module 40 analyzes an associate's capability assessment level to determine other opportunities for the associate within the organization that align with the associate's capabilities.

Capability development module 40 may include a network server, any suitable remote server, a mainframe, a host computer, a workstation, a web server, a personal computer, a file server, or any other suitable device operable to communicate with manager computers 12, associate computers 16, and/or training module 30. In some embodiments, capability development module 40 may execute any suitable operating system such as IBM's zSeries/Operating System (z/OS), MS-DOS, PC-DOS, MAC-OS, WINDOWS, UNIX, OpenVMS, or any other appropriate operating system, including future operating systems. The functions of capability development module 40 may be performed by any suitable combination of one or more servers or other components at one or more locations. In the embodiment where capability development module 40 is a server, the server may be a private server, and the server may be a virtual or physical server. The server may include one or more servers at the same or remote locations. Also, capability development module 40 may include any suitable component that functions as a server. In the illustrated embodiment, capability development module 40 includes a network interface 42, a processor 44, and a memory 46.

Network interface 42 represents any suitable device operable to receive information from network 22, transmit information through network 22, perform processing of information, communicate with other devices, or any combination of the preceding. For example, network interface 42 receives various skills associated with jobs in the organization from manager computer 12. As another example, network interface 42 receives capability assessment levels from manager computers 12 and/or associate computers 16. As yet another example, network interface 42 may communicate training information to associate computer 16. Additionally, network interface 42 may communicate various reports to manager computers 12 regarding an associates' capability, a business units' capability, and/or an organization's capability. Network interface 42 represents any port or connection, real or virtual, including any suitable hardware and/or software, including protocol conversion and data processing capabilities, to communicate through a LAN, WAN, or other communication system that allows capability development module 40 to exchange information with network 22, manager computers 12, associate computers 16, training module 30, or other components of system 10.

Processor 44 communicatively couples to network interface 42 and memory 46, and controls the operation and administration of capability development module 40 by processing information received from network interface 42 and memory 46. Processor 44 includes any hardware and/or software that operates to control and process information. For example, processor 44 executes rules 48 to control the operation of capability development module 40. Processor 44 may be a programmable logic device, a microcontroller, a microprocessor, any suitable processing device, or any suitable combination of the preceding.

Memory 46 stores, either permanently or temporarily, data, operational software, or other information for processor 44. Memory 46 includes any one or a combination of volatile or non-volatile local or remote devices suitable for storing information. For example, memory 46 may include RAM, ROM, magnetic storage devices, optical storage devices, or any other suitable information storage device or a combination of these devices. In the illustrated embodiment, memory 46 includes rules 48, skills 50, and capability levels 52.

Rules 48 generally refer to logic, rules, algorithms, code, tables, and/or other suitable instructions embodied in a computer-readable storage medium for performing the described functions and operations of capability development module 40. For example, rules 48 facilitate the determination of a training program for an associate to improve their capability level. In an embodiment, the training program determination may be made based on the skill level associated with the particular skill and the associate's current capability assessment level. As another example, rules 48 facilitate the identification of opportunities in the organization for an associate based on an associate's improved capability assessment level. To identify these other opportunities, rules 48 may reference the type of capability in addition to the level of the capability assessment. While illustrated as including a particular module, memory 46 may include any suitable information for use in the operation of capability development module 40.

Skills 50 generally refer to the various skills associated with a position in the organization. Manager computer 12 communicates skills to capability development module 40, and capability development module 40 stores skills 50 to use in evaluating a current state of an associate, in determining a training program for an associate, and/or in determining additional opportunities for an associate within the organization. Skills 50 may vary depending on the position within the organization. For example, for an associate in the technology business unit, the associated skills 50 may include application development, product support, project management, testing, architecture, and infrastructure. Skills 50 may also refer to sub-skills of each skill. As an example, the testing skill area may have sub-skills, such as certifications, test design, test execution, test management, and test planning and strategy. Manager computer 12 may also communicate the sub-skills to capability development module 40, and capability development module 40 stores the information in memory 46.

Capability levels 52 refer to the assessment level of an associate in different skill areas. Manager computer 12 and/or associate computer 16 communicate the capability assessment levels to capability development module 40 and they are stored as capability levels 52. Capability development module 40 may retrieve capability levels 52 to evaluate the state of an associate, to determine an appropriate training program for the associate, and/or to determine additional opportunities for the associate in the organization.

In an exemplary embodiment of operation, capability development module 40 receives a skill associated with a particular position in the organization from manager computer 12. Capability development module 40 determines a skill level associated with the received skill. Capability development module 40 may then receive a capability assessment level from manager computer 12 and/or associate computer 16. The capability assessment level represents the current capability level of an associate in a specific area. For example, if a particular job requires an associate to have project management ability, the capability assessment level represents the associate's capability at project management.

Capability development module 40 compares the skill level of the position with the capability assessment level of the associate. If the skill level is greater than the associate's capability assessment level, capability development module 40 will determine a training program based on the capability assessment level and the skill level. The training recommendation is communicated to manager computer 12 and/or associate computer 16. An associate then completes the training program and updates the capability assessment level upon completion of the training program.

If the skill level is not greater than the capability assessment level, capability development module 40 determines whether the skill level needs to be updated. If the skill level is updated, capability development module 40 determines whether the updated skill level is greater than the capability assessment level and determines a suitable training program if appropriate.

If the skill level is not updated, capability development module 40 identifies other opportunities within the organization for the associate. For example, if an associate has improved their capability assessment level and is better fit to work in a different capacity within the organization, capability development module 40 identifies those additional opportunities. Capability development module 40 may then communicate the opportunities to manager computer 12 and/or associate computer 16.

A component of system 10 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 10 without departing from the scope of the invention. For example, system 10 may include any number of manager computers 12, associate computers 16, networks 22, training modules 30, and capability development modules 40. Any suitable logic may perform the functions of system 10 and the components within system 10.

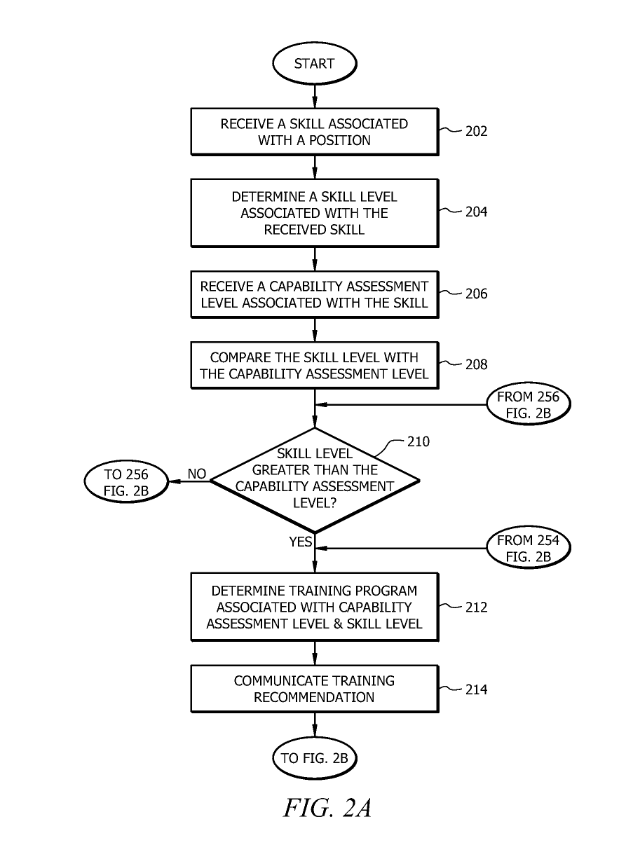

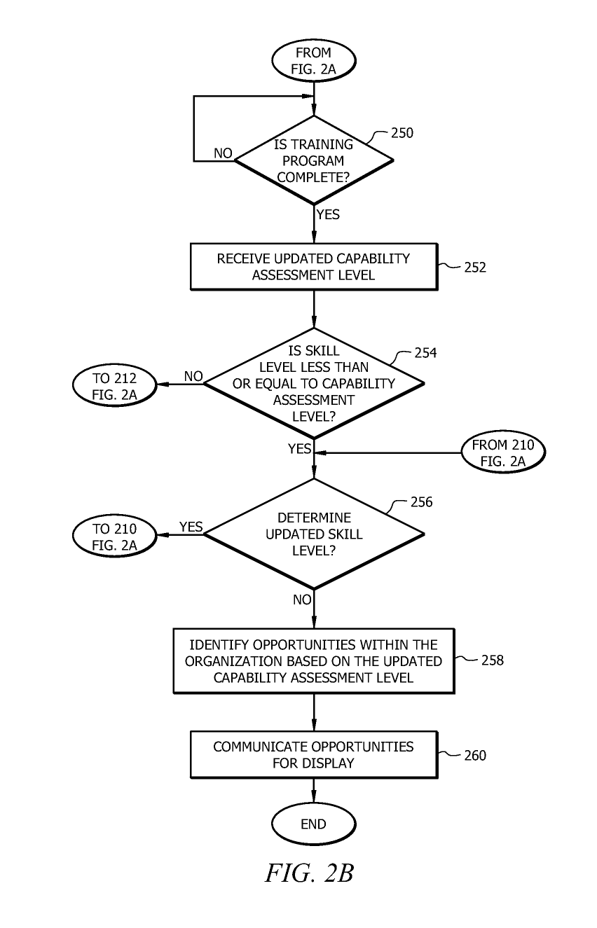

FIGS. 2A-2B illustrate flowcharts for capability development in the organization. At step 202, capability development module 40 receives a skill associated with a position. In an embodiment, a manager enters this information into manager computer 12, and manager computer 12 communicates the skill to capability development module 40. The skills may include various skills necessary for a particular job within the organization. For example, skills may include application development, product support, project management, testing, architecture, infrastructure. Within each skill area, there may be associated sub-skills as defined by the organization and/or the manager. For example, within the application development skill set, sub-skills may include: code construction, reviews, testing; communication; process governance; requirements management, solution design, and architecture; and tools and platform usage. Within the product support skill set, sub-skills may include: analytical skills, application architecture, application knowledge, documentation/reporting skills, problem triage skills, and technical knowledge. Within the project management skill set, sub-skills may include application knowledge, certifications, general management skills, and project management knowledge. Within the testing skill set, sub-skills may include certifications, test design, test execution, test management, and test planning and strategy. Each position may have any number of associated skills and sub-skills as defined by the manager and/or the organization. By evaluating across a broad range of skill areas, capability development module 40 facilitates multi-dimensional assessment. This assessment considers an associate's role, their technical ability, their domain, their leadership, and their knowledge of applications for their position.

At step 204, capability development module 40 determines a skill level associated with each skill or sub-skill. For example, capability development module 40 may determine that each sub-skill is evaluated on a five-point scale. In a particular embodiment, each level on a five-point scale represents a particular capability level. For example, a one represents a novice associate, a two represents a trained associate, a three represents a practicing associate, a four represents an expert associate, and a five represents a master associate. Each level of capability may have a particular definition to guide the assessment process. For example, a novice associate may be defined as having no awareness of the position, a trained associate may have developed awareness of the competency through training, a practicing associate may have the ability to practice with assistance, an expert associate may have the ability to practice without assistance, and a master associate may have the ability to develop competency in others. These specific capability levels may change based on the organization. In an embodiment, manager computer 12 communicates the skill level to capability development module 40 in addition to the skill associated with the position.

At step 206, capability development module 40 receives a capability assessment level associated with the skill. The capability assessment level represents an associate's current capability level with a skill. Manager computer 12 and/or associate computer 12 may communicate this information to capability development module 40. For example, a manager may provide this information while evaluating subordinates, or an associate may provide this information while conducting a self-evaluation. The capability assessment level may be evaluated on any suitable scale, such as on a five-point scale.

At step 208, capability development module 40 compares the skill level with the capability assessment level to determine how an associate compares to the required skill level. If the skill level is greater than the capability assessment level at step 210, capability development module 40 determines a training program for the associate at step 212. The training program may be associated with the capability assessment level and skill level. The particular training program may be determined based on the skill level and the capability assessment level. At step 214, capability development module 40 communicates the training recommendation to manager computer 12 and/or associate computer 16. With the training recommendations, capability development module 40 may provide information that facilitates the planning of training programs within an organization. For example, if capability development module 40 determines that ten associates should receive training on a specific topic, that information may be used to determine to host training on the specific topic. The method then proceeds from FIG. 2B.

If the skill level is not greater than the capability level at step 210, the method proceeds to step 258 in FIG. 2B, which will be discussed in greater detail below.

At step 250 in FIG. 2B, capability development module 40 determines whether the training program is complete. Capability development module 40 may monitor the various training programs that associates undertake. The training programs may be associated with a specific timeline or the associates may be allowed to complete the training programs at their convenience. If the training program is not complete, capability development module 40 continues to monitor when the associate completes the training.

If the training program is complete, capability development module 40 receives an updated capability assessment level at step 252. After the training is complete, the manager and/or the associate receives a prompt to update the capability assessment level of the associate. In an embodiment, capability development module 40 communicates a notification to manager computer 12 and/or associate computer 16 to update the capability assessment level of the associate that completed the training The updated capability assessment level may reflect the additional training and experience that the associate receives.

At step 254, capability development module 40 determines whether the skill level is less than or equal to the capability assessment level. If the skill level is greater than the capability assessment level, the method proceeds from step 212 in FIG. 2A. If the skill level is less than or equal to the capability assessment level, capability development module 40 determines whether to update the skill level at step 256. For example, capability development module 40 may determine that the current skill level does not reflect the highest competency level for the associated skill and updates the skill level accordingly. If the skill level is updated, the method proceeds from step 210 in FIG. 2A. If the skill level is not updated, capability development module 40 identifies opportunities within the organization based on the updated capability assessment level at step 258. For example, if an associate has reached a particular capability level and may be better suited for another position within the organization, capability development module 40 determines those additional opportunities by considering the updated capability assessment level. In addition to the capability assessment level, capability development module 40 may consider the capability type, a combination of the capability assessment level and capability type, or any other suitable information. At step 260, capability development module 40 communicates those opportunities to manager computer 12 and/or associate computer 16 for display. As an associate transitions into different opportunities within the organization, the capability assessment remains with the associate for other business units to leverage.

Modifications, additions, or omissions may be made to method depicted in FIGS. 2A-2B. In an embodiment, if the skill level is less than the capability assessment level, capability development module 40 may identify suitable opportunities that utilize the under-utilized competencies or the additional competencies of an associate. Capability development module 40 may communicate this information to manager computer 12. The method may include more, fewer, or other steps. Additionally, steps may be performed in parallel or in any suitable order. Any suitable component of system 10 may perform one or more steps of the method.

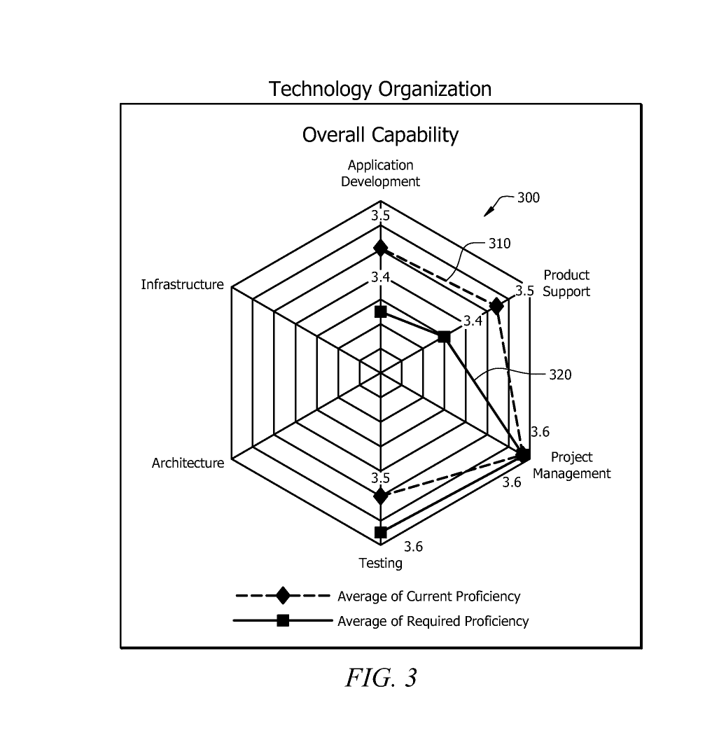

FIG. 3 illustrates an example chart 300 that indicates overall capability results of an associate. Example chart 300 may be displayed to a user of manager computer 12 and/or associate computer 16. In the illustrated embodiment, chart 300 displays the capability of an associate in six different areas: application development, product support, project management, testing, architecture, and infrastructure.

Each skill area has an associated proficiency that is indentified on a five-point scale, and an associate is evaluated in each skill area on the five-point scale. For each skill, the chart displays the current proficiency of the associate as indicated by line 310 and the required proficiency for the skill as indicated by line 320. In the illustrated embodiment, the evaluated associate has a proficiency of 3.5 in application development, a proficiency of 3.5 in product support, a proficiency of 3.6 in project management, and a proficiency of 3.5 in testing. The required proficiency for each of the skill areas is as follows: 3.4 for application development, 3.4 for product support, 3.6 for project management, and 3.6 for testing.

As shown in chart 300, the evaluated associate has a higher proficiency in application development and product support, meets the required proficiency in project management, and has a lower proficiency in testing. Based on this evaluation, capability development module 40 determines that the associate may benefit from additional training in the testing area. Capability development module 40 determines a training program that would facilitate the associate's growth in that area and communicates the training program to manager computer 12 and/or associate computer 16.

Modifications, additions, or omissions may be made to chart 300 without departing from the scope of the invention. While the illustrated embodiment represents example skills for a technology position, different skills may be evaluated based on the required skills for a position. As an example, different skills may be associated with positions in operations, support functions, finance, human resources, or other groups within an organization.

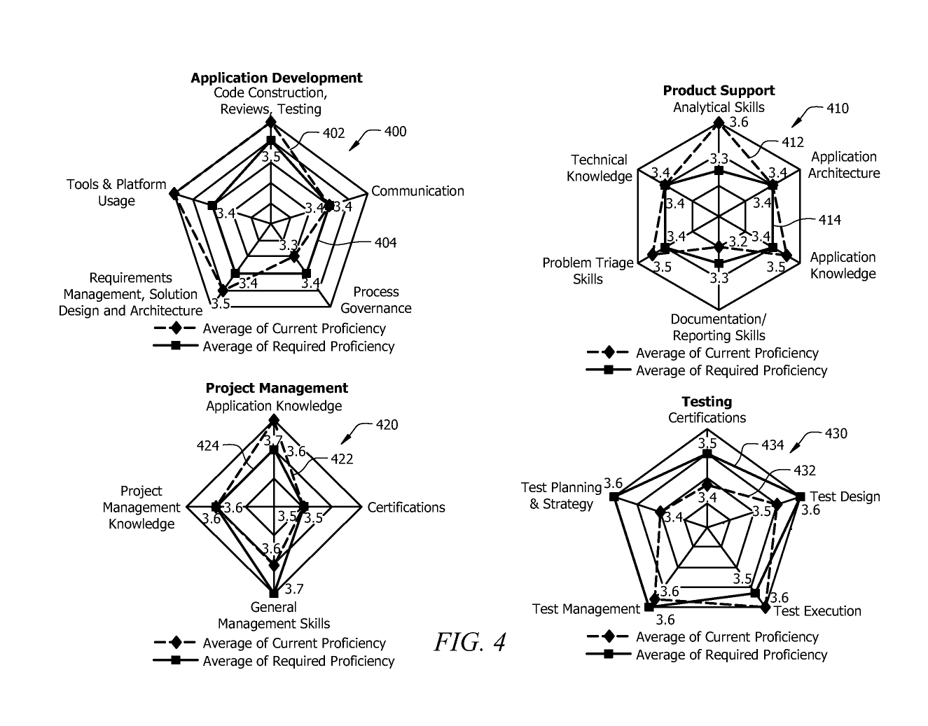

FIG. 4 illustrates example charts that indicate capability results in specific skill areas. Each chart provides more detailed information about an associate's capability in the different skill areas. In an embodiment, capability development module 40 communicates the various charts in FIG. 4 to manager computer 12 and/or associate computer 16.

Chart 400 indicates an associate's capability in application development. Within the application development skill area, the specific skills that are measured include: code construction, reviews, and testing; communication; process governance; requirements management, solution design, and architecture; and tools and platform usage. Each skill area has an associated proficiency that is indentified on a five-point scale, and an associate is evaluated in each skill area on the five-point scale. For each skill, the chart displays the current proficiency of the associate as indicated by line 402 and the required proficiency for the skill as indicated by line 404.

In the illustrated embodiment, the evaluated associate has a proficiency of 3.6 in code construction, reviews, and testing; a proficiency of 3.4 in communication; a proficiency of 3.3 in process governance; a proficiency of 3.5 in requirements management, solution design, and architecture; and a proficiency of 3.6 in tools and platform usage. In an example embodiment, capability development module 40 receives the associate's current capability assessment level, or proficiency, from manager computer 12 and/or associate computer 16.

The required proficiency for each of the skill areas is as follows: 3.5 in code construction, reviews, and testing; 3.4 in communication; 3.4 in process governance; 3.4 in requirements management, solution design, and architecture; and 3.4 in tools and platform usage. In an example embodiment, capability development module 40 receives the required skill level, or proficiency, for each skill from manager computer 12.

As illustrated in chart 400, the evaluated associate has a higher proficiency in code construction, reviews, and testing; requirements management, solution design, and architecture; and tools and platform usage; meets the required proficiency in communication; and has a lower proficiency in process governance. Capability development module 40 evaluates the received capability assessment level for each skill under application development and determines a capability assessment level for the application development skill area. The capability assessment level for the application development skill area is shown in a chart similar to chart 300 in FIG. 3.

Chart 410 indicates an associate's capability in product support. Within the product support skill area, the specific skills that are measured include: analytical skills, application architecture, application knowledge, documentation/reporting skills, problem triage skills, and technical knowledge. Each skill area has an associated proficiency that is indentified on a five-point scale, and an associate is evaluated in each skill area on the five-point scale. For each skill, the chart displays the current proficiency of the associate as indicated by line 412 and the required proficiency for the skill as indicated by line 414.

In the illustrated embodiment, the evaluated associate has a proficiency of 3.6 in analytical skills; a proficiency of 3.4 in application architecture; a proficiency of 3.5 in application knowledge; a proficiency of 3.2 in documentation/reporting skills; a proficiency of 3.5 in problem triage skills, and a proficiency of 3.4 in technical knowledge. In an example embodiment, capability development module 40 receives the associate's current capability assessment level, or proficiency, from manager computer 12 and/or associate computer 16.

The required proficiency for each of the skill areas is as follows: 3.3 in analytical skills; 3.4 in application architecture; 3.4 in application knowledge; 3.3 in documentation/reporting skills; 3.4 in problem triage skills, and 3.4 in technical knowledge. In an example embodiment, capability development module 40 receives the required skill level, or proficiency, for each skill from manager computer 12.

As illustrated in chart 410, the evaluated associate has a higher proficiency in analytical skills, application knowledge, and problem triage skills; meets the required proficiency in application architecture and technical knowledge; and has a lower proficiency in documentation/reporting skills. Capability development module 40 evaluates the received capability assessment level for each skill under product support and determines a capability assessment level for the product support skill area. The capability assessment level for the product support skill area is shown in a chart similar to chart 300 in FIG. 3.

Chart 420 indicates an associate's capability in project management. Within the project management skill area, the specific skills that are measured include: application knowledge, certifications, general management skills, and project management knowledge. Each skill area has an associated proficiency that is indentified on a five-point scale, and an associate is evaluated in each skill area on the five-point scale. For each skill, the chart displays the current proficiency of the associate as indicated by line 422 and the required proficiency for the skill as indicated by line 424.

In the illustrated embodiment, the evaluated associate has a proficiency of 3.7 in application knowledge, a proficiency of 3.5 in certifications, a proficiency of 3.6 in general management skills, and a proficiency of 3.6 in project management knowledge. In an example embodiment, capability development module 40 receives the associate's current capability assessment level, or proficiency, from manager computer 12 and/or associate computer 16.

The required proficiency for each of the skill areas is as follows: 3.6 in application knowledge, 3.5 in certifications, 3.7 in general management skills; and 3.6 in project management knowledge. In an example embodiment, capability development module 40 receives the required skill level, or proficiency, for each skill from manager computer 12.

As illustrated in chart 420, the evaluated associate has a higher proficiency in application knowledge; meets the required proficiency in certifications and project management knowledge; and has a lower proficiency in general management skills. Capability development module 40 evaluates the received capability assessment level for each skill under project management and determines a capability assessment level for the project management skill area. The capability assessment level for the project management skill area is shown in a chart similar to chart 300 in FIG. 3.

Chart 430 indicates an associate's capability in testing. Within the testing skill area, the specific skills that are measured include: certifications, test design, test execution, test management, and test planning and strategy. Each skill area has an associated proficiency that is indentified on a five-point scale, and an associate is evaluated in each skill area on the five-point scale. For each skill, the chart displays the current proficiency of the associate as indicated by line 432 and the required proficiency for the skill as indicated by line 434.

In the illustrated embodiment, the evaluated associate has a proficiency of 3.4 in certifications, a proficiency of 3.5 in test design, a proficiency of 3.6 in test execution, a proficiency of 3.6 in test management, and a proficiency of 3.4 in test planning and strategy. In an example embodiment, capability development module 40 receives the associate's current capability assessment level, or proficiency, from manager computer 12 and/or associate computer 16.

The required proficiency for each of the skill areas is as follows: 3.5 in certifications, 3.6 in test design, 3.5 in test execution, 3.6 in test management, and 3.6 in test planning and strategy. In an example embodiment, capability development module 40 receives the required skill level, or proficiency, for each skill from manager computer 12.

As illustrated in chart 430, the evaluated associate has a higher proficiency in test execution, meets the required proficiency in test management, and has a lower proficiency in certifications, test design, and test planning and strategy. Capability development module 40 evaluates the received capability assessment level for each skill under testing and determines a capability assessment level for the testing skill area. The capability assessment level for the testing skill area is shown in a chart similar to chart 300 in FIG. 3.

Modifications, additions, or omissions may be made to the charts in FIG. 4 without departing from the scope of the invention. While the illustrated embodiment represents specific skills in different skill areas, any suitable skill in any suitable skill area may be evaluated and displayed in a similar manner.

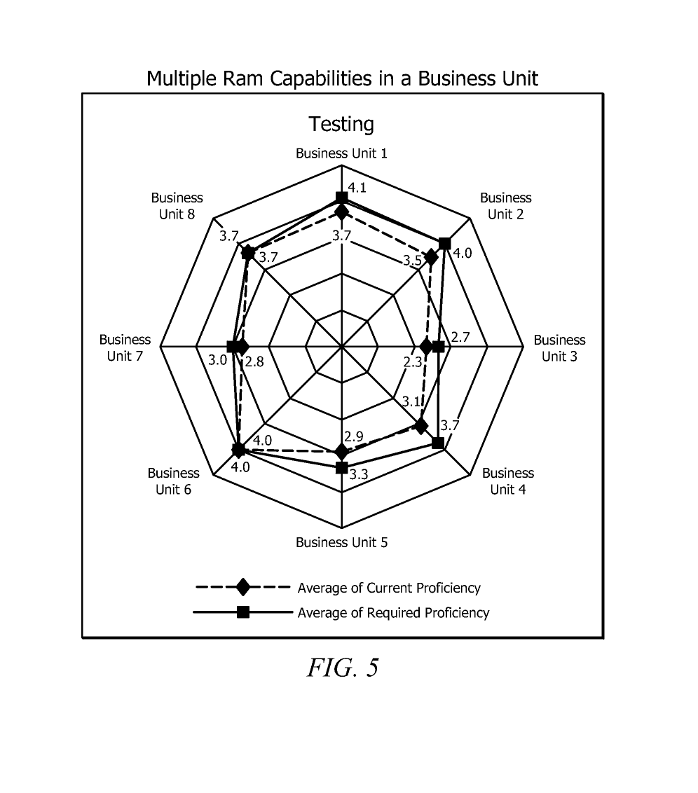

FIG. 5 illustrates an example chart 500 that indicates the capability results of various business units in the organization. Capability development module 40 gathers the skill levels and capability assessment levels from the associates in various business units, and compiles information regarding each business unit. Chart 500 illustrates the compiled data across the various business units.

In the illustrated embodiment, chart 500 indicates the current proficiency of each business unit in the testing skill area and also indicates the required proficiency of each business unit. Each business unit is evaluated in each skill area on the five-point scale. The chart displays the current proficiency of the business unit as indicated by line 510 and the required proficiency for the skill as indicated by line 520. As shown in chart 500, some of the business units within the organization meet the required proficiency, while other business units have a proficiency that is less than the required proficiency.

Modifications, additions, or omissions may be made to chart 500 without departing from the scope of the invention. Chart 500 may display proficiency information for any number of business units in the organization. Additionally, similar charts may be generated and displayed that indicate the proficiency of business units in a different skill area.

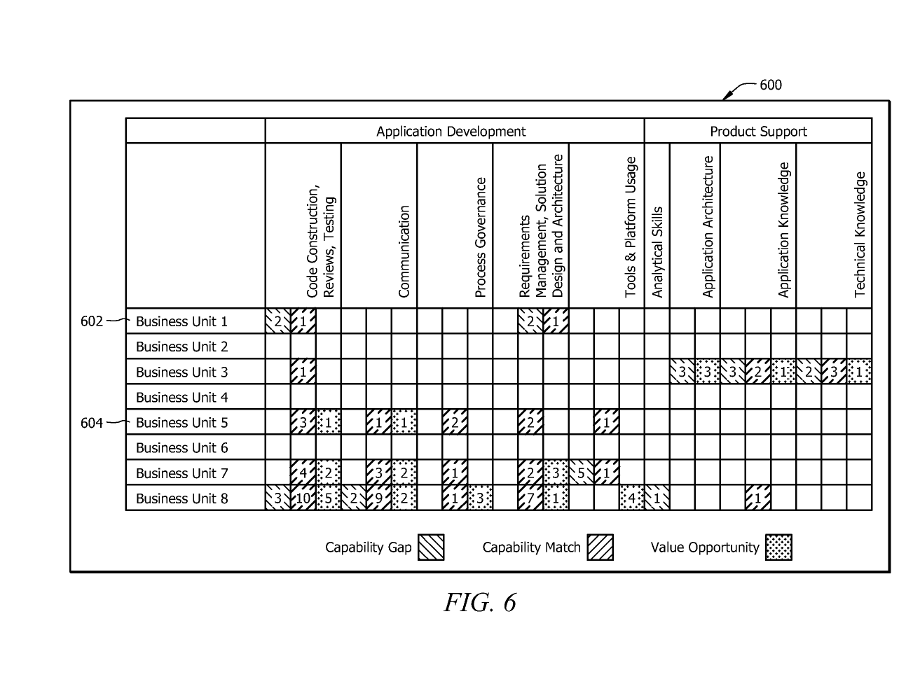

FIG. 6 illustrates an example table 600 that indicates capability results of various business units in the organization. Table 600 indicates where the associates fall in each skill area across the different business units within the organization. For example, table 600 indicates the following: how many associates have capability assessment levels that match the required skill level, how many associates have capability assessment levels that fall below the required skill level, and how many associates have capability assessment levels that are above the required skill level.

In the illustrated embodiment, row 602 indicates the capability assessment levels for associates in Business Unit 1. Under the application development skill area, table 600 displays the gathered information in each sub-skill area. For code construction, reviews, and testing, two associates in Business Unit 1 have capability assessment levels that fall below the required skill level and one associate has a capability assessment level that matches the skill level.

As another example, row 604 indicates the capability assessment levels for associates in Business Unit 5. For code construction, reviews, and testing, three associates in Business Unit 5 have capability assessment levels that match the required skill level and one associate has a capability assessment level that is higher than the required skill level.

Modifications, additions, or omissions may be made to table 600 without departing from the scope of the invention. Table 600 may display proficiency information for any number of business units in the organization. Additionally, similar charts may be generated and displayed that indicate the proficiency of business units in different skill areas.

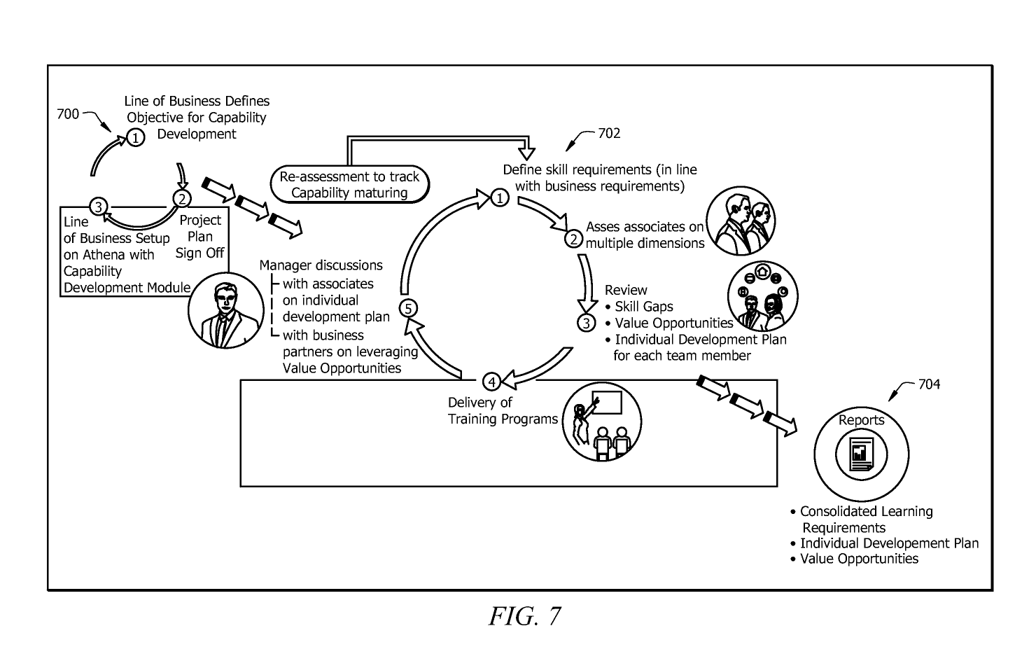

FIG. 7 illustrates an example of the lifecycle of the capability development in the organization. At 700, the process begins with the line of business defining the objectives for capability development. During these initial phases, there is sign-off of the project plan and the line of business is setup with the capability development module.

At 702, the skill requirements are defined. The skill requirements are in line with the business requirements. Associates are assessed on multiple dimensions, and then a review of the skill gaps, value opportunities, and individual development plan for each team member occurs. After the review, a manager plans to action the capability gaps through structured training as per business priorities. To do this, a manager plans the delivery of training programs with a learning and development team. The manager discusses the individual development plan with the associate, and leveraging meaningful value opportunities with business partners. The associate executes the individual development plan and confirms this to the managers. The associates are re-assessed by the managers to track their capability maturity and the process continues.

At 704, reports are provided that have consolidated learning requirements, an individual development plan, and value opportunities within the organization.

Certain embodiments of the present disclosure may provide one or more technical advantages. A technical advantage of one embodiment includes providing a learning and talent management framework to measure employee capability and maturity development. Another technical advantage includes determining a particular training program based on a current capability level and a desired capability level. Yet another technical advantage includes providing a knowledge management structure and standardized approach to leverage consistent employee development that is mapped to organization standards; thereby creating an environment to promote maturation of organizational capability. By promoting associate development and maturation, an organization may further experience efficiency in other resources, such as computing resources.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system for capability development in an organization, comprising
a network interface operable to:
receive a skill associated with a position in an organization from a first computer associated with a manager; and
receive a capability assessment level associated with the skill;
a processor communicatively coupled to the network interface and operable to:
determine a skill level associated with the received skill;
compare the skill level and the capability assessment level to determine a current state; and
if the skill level is greater than the capability assessment level, determine a training program based on the capability assessment level and the skill level.

2. The system of claim 1, wherein the network interface is operable to receive the capability assessment level from the first computer associated with the manager.

3. The system of claim 1, wherein the network interface is operable to receive the capability assessment level from a second computer associated with an associate.

4. The system of claim 1, wherein:
the processor is further operable to determine whether the training program is complete; and
the interface is further operable to receive an updated capability assessment level if the training program is complete.

5. The system of claim 1, wherein the processor is further operable to determine whether to update the skill level associated with the skill if the skill level is less than or equal to the capability assessment level.

6. The system of claim 5, wherein the processor is further operable to determine whether to update the skill level by:
determining the current skill level; and
determining whether a higher skill level is associated with the skill.

7. The system of claim 1, wherein the processor is further operable to determine opportunities in the organization based on the updated capability assessment level.

8. Non-transitory computer readable medium comprising logic, the logic, when executed by a processor, operable to:
receive a skill associated with a position in an organization from a first computer associated with a manager;
determine a skill level associated with the received skill;
receive a capability assessment level associated with the skill;
compare the skill level and the capability assessment level to determine a current state; and
if the skill level is greater than the capability assessment level, determine a training program based on the capability assessment level and the skill level.

9. The computer readable medium of claim 8, wherein receiving a capability assessment level associated with the skill comprises receiving the capability assessment level from the first computer associated with the manager.

10. The computer readable medium of claim 8, wherein the logic is further operable to:
determine whether the training program is complete; and
receive an updated capability assessment level if the training program is complete.

11. The computer readable medium of claim 8, wherein the logic is further operable to determine whether to update the skill level associated with the skill if the skill level is less than or equal to the capability assessment level.

12. The computer readable medium of claim 11, wherein determining whether to update the skill level comprises:
determining the current skill level; and
determining whether a higher skill level is associated with the skill.

13. The computer readable medium of claim 8, wherein the logic is further operable to determine opportunities in the organization based on the updated capability assessment level.

14. A method for capability development in an organization, comprising
receiving a skill associated with a position in an organization from a first computer associated with a manager;
determining, by a processor, a skill level associated with the received skill;
receiving a capability assessment level associated with the skill;
comparing, by the processor, the skill level and the capability assessment level to determine a current state; and
if the skill level is greater than the capability assessment level, determining, by the processor, a training program based on the capability assessment level and the skill level.

15. The method of claim 14, wherein receiving a capability assessment level associated with the skill comprises receiving the capability assessment level from the first computer associated with the manager.

16. The method of claim 14, wherein receiving a capability assessment level associated with the skill comprises receiving the capability assessment level from a second computer associated with an associate.

17. The method of claim 14, further comprising:
determining whether the training program is complete; and
receiving an updated capability assessment level if the training program is complete.

18. The method of claim 14, further comprising determining whether to update the skill level associated with the skill if the skill level is less than or equal to the capability assessment level.

19. The method of claim 18, wherein determining whether to update the skill level comprises:
determining the current skill level; and
determining whether a higher skill level is associated with the skill.

20. The method of claim 14, further comprising determining opportunities in the organization based on the updated capability assessment level.
